(19) United States
(12) Patent Application Publication
(10) Pub. No.: US 2017/0046879 A1
(43) Pub. Date: Feb. 16, 2017

(54) AUGMENTED REALITY WITHOUT A PHYSICAL TRIGGER

(71) Applicants: Robert Paul SEVERN, San Francisco, CA (US); AURASMA LIMITED, Bracknell (GB)

(72) Inventor: Robert Paul Severn, San Francisco, CA (US)

(21) Appl. No.: 15/305,958

(22) PCT Filed: Apr. 30, 2014
(86) PCT No.: PCT/US2014/036108

§ 371 Date: Oct. 21, 2016

(51) Int. Cl. G06T 19/00; G06T 7/00

(52) U.S. Cl. CPC G06T 19/006; G06T 7/0085; G06T 2200/04; G06T 2200/24

(57) ABSTRACT

In an example, an augmented reality experience is displayed without a physical trigger. A trigger image for an augmented reality experience is selected by a processor of a computing device. A planar surface in a real-world environment is detected to frame the trigger image. The trigger image is then superimposed on top of a camera feed of the planar surface. Accordingly, the augmented reality experience is activated on a display, wherein the augmented reality experience includes the superimposed trigger image.

### BACKGROUND

Augmented reality is the integration of digital information with a real-world environment. In particular, augmented reality provides a live, direct, or indirect, view of a physical, real-world environment whose elements are augmented by computer-generated sensory input such as sound, video, graphics, or GPS data. Augmented reality includes the recognition of an image, an object, a face, or any element within the real-world environment and the tracking of that image by utilizing real-time localization in space. Augmented reality also includes superimposing digital media, such as video, three-dimensional (3D) images, graphics, and text, on top of a view of the real-world environment to integrate the digital media with the real-world environment.

### BRIEF DESCRIPTION OF THE DRAWINGS

Features of the present disclosure are illustrated by way of example and not limited in the following figure(s), in which like numerals indicate like elements, in which:

FIG. 1 shows a block diagram of a computing device to display an augmented reality experience without a physical trigger, according to an example of the present disclosure;

FIGS. 2A-2D shows sequential frames demonstrating a method to display an augmented reality experience without a physical trigger, according to an example of the present disclosure; and

FIG. 3 shows a flow diagram of a method to display an augmented reality experience without a physical trigger, according to an example of the present disclosure.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Disclosed herein are examples of a method to display an augmented reality experience without a physical trigger. Also disclosed herein is a system for implementing the methods and a non-transitory computer readable medium on which is stored machine readable instructions that implement the methods. According to an example, the method to display an augmented reality experience without a physical trigger is implemented or invoked in an augmented reality platform stored on a computing device such as, but not limited to, a smartphone, a computing tablet, a laptop computer, a desktop computer, or any wearable computing device.

Augmented reality is the layering of digital media onto a real-world environment. Specifically, augmented reality is a view of a physical, real-world environment whose elements are supplemented with digital media such as images, videos, sounds, three-dimensional (3D) graphics, or GPS data. The digital media is activated when a pre-defined element from the real-world environment (i.e., a physical trigger) is recognized by a computer vision or image recognition software associated with an augmented reality platform that is stored in a computing device. The physical trigger includes, but is not limited to, a designated image, object, location, person, or other element from the real-world environment.

According to an example, each physical trigger is associated with an augmented reality experience. The augmented reality experience includes overlaying digital media onto the physical trigger to provide a user with real-time informational context for the physical trigger. The informational context presented by the digital media provides a user with a better understanding of the real-world environment of the physical trigger. For example, a physical trigger such as a sporting event may include superimposed visual elements, such as lines that appear to be on the field, arrows that indicate the movement of an athlete, or graphics that display statistics related to the sporting event. Thus, the augmented reality experience provides enhanced digital media information about the real-world to be overlaid onto a view of the real-world.

Typically, an augmented reality platform uses a camera to scan the real-world environment for a physical trigger to activate the overlay of digital media information onto the real-world environment. Particularly, the augmented reality platform will scan the real-world environment for a physical trigger that matches a stored image of the physical trigger. When a match is identified, digital media can then be superimposed onto a view of the physical trigger.

According to the disclosed examples, the augmented reality experience is provided in situations where a user has no access to a physical, scannable trigger. In an example, an augmented reality experience is displayed without a physical trigger. A trigger image for an augmented reality experience is selected. A planar surface in a real-world environment is detected to frame the trigger image. The trigger image is then superimposed on top of a camera feed of the planar surface. Accordingly, the augmented reality experience is activated on a display, wherein the augmented reality experience includes the superimposed trigger image. Thus, the disclosed examples provide the benefit and incentive of increased usability of an augmented reality platform by retaining users that do not have access to physical triggers.

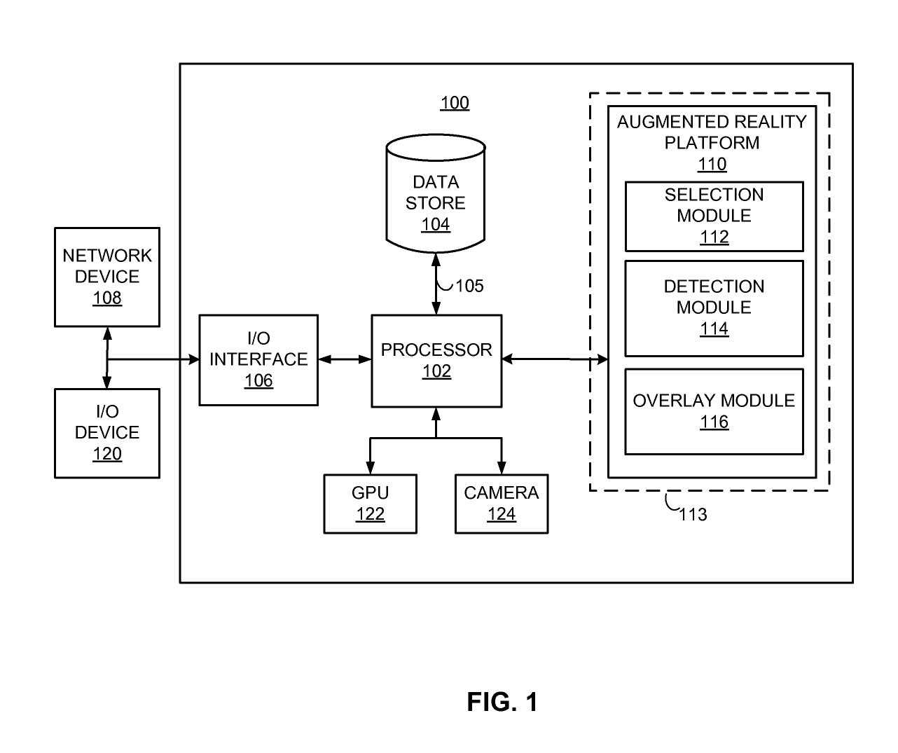

With reference to FIG. 1, there is shown a block diagram of a computing device 100 to display an augmented reality experience without a physical trigger according to an example of the present disclosure. It should be understood that the computing device 100 may include additional components and that one or more of the components described herein may be removed and/or modified without departing from a scope of the computing device 100.

The computing device 100 is depicted as including a processor 102, a data store 104, an input/output (I/O) interface 106, an augmented reality platform 110, a graphics processing unit (GPU) 122, and a camera 124. For example, the computer may be smartphone, a computing tablet, a laptop computer, a desktop computer, or any type of wearable computing device. Also, the components of the computing device 100 are shown on a single computer as an example and in other examples the components may exist on multiple computers. The computing device 100 may store a table in the data store 104 and/or may manage the storage of data in a table stored in a separate computing device, for instance, through a network device 108, which includes, for instance, a router, a switch, a hub, etc. The data store 104 may include physical memory such as a hard drive, an optical drive, a flash drive, an array of drives, or any combinations thereof, and may include volatile and/or non-volatile data storage.

The augmented reality platform 110 is depicted as including a selection module 112, a detection module 114, and an overlay module 116. The processor 102, which may comprise a microprocessor, a micro-controller, an application specific integrated circuit (ASIC), or the like, is to perform various processing functions in the computing device 100. The processing functions may include the functions of the modules 112-116 of the augmented reality platform 110. The augmented reality platform 110 is used to superimpose an augmented reality experience on top of a trigger image. The augmented reality platform 128 is, for example, an application that is downloaded to the data store 104.

The selection module 112, for example, provides an interface to display a plurality of trigger images to a user on a display of the computing device 100. According to an example, each of the plurality of trigger images is associated with a unique augmented reality experience. The selection module 112 receives a user selection of at least one of the plurality of trigger images and imports the trigger image and the augmented reality experience from the local data store 104 or a remote database server. After the trigger image is selected by the selection module 112, the user may initiate a preview mode on the computing device 100 to view an augmented reality experience for the selected trigger image. The preview mode, for instance, activates the display and the camera 124 of the computing device 100.

The detection module 114, for example, detects an image of a planar surface in a real-world environment to frame the trigger image using the camera 124 during the preview mode. In this regard, the preview mode may display a captured view of the planar surface on the display of the computing device 100. Particularly, the detection module 114 may display a message for a user to locate a suitable planar surface from the real-world environment using the camera 124 of the computing device 100 and display a notification responsive to the user successfully locating a suitable planar surface. According to an example, a planar surface is suitable if it is rectangular in shape.

The overlay module 116, for example, superimposes the trigger image on the captured view of the suitable planar surface and then superimposes the augmented reality experience on top of the trigger image. Accordingly, in an augmented reality experience mode, the augmented reality experience is activated for display on the computing device 100 without a physical trigger from a real-world environment.

In an example, the augmented reality platform 110 includes machine readable instructions stored on a non-transitory computer readable medium 113 and executed by the processor 102. Examples of the non-transitory computer readable medium include dynamic random access memory (DRAM), electrically erasable programmable read-only memory (EEPROM), magnetoresistive random access memory (MRAM), memristor, flash memory, hard drive, and the like. The computer readable medium 113 may be included in the data store 104 or may be a separate storage device. In another example, the augmented reality platform 110 includes a hardware device, such as a circuit or multiple circuits arranged on a board. In this example, the modules 112-116 comprise circuit components or individual circuits, such as an embedded system, an ASIC, or a field-programmable gate array (FPGA).

The processor 102 may be coupled to the data store 104, the I/O interface 106, the GPU 122, and the camera 124 by a bus 105 where the bus 105 may be a communication system that transfers data between various components of the computing device 100. In examples, the bus 105 may be a Peripheral Component Interconnect (PCI), Industry Standard Architecture (ISA), PCI-Express, HyperTransport®, NuBus, a proprietary bus, and the like.

The I/O interface 106 includes a hardware and/or a software interface. The I/O interface 106 may be a network interface connected to a network through the network device 108, over which the augmented reality platform 110 may receive and communicate information, for instance, information regarding a trigger image or an augmented reality experience. For example, the input/output interface 106 may be a wireless local area network (WLAN) or a network interface controller (NIC). The WLAN may link the computing device 100 to the network device 108 through a radio signal. Similarly, the NIC may link the computing device 100 to the network device 108 through a physical connection, such as a cable. The computing device 100 may also link to the network device 108 through a wireless wide area network (WWAN), which uses a mobile data signal to communicate with mobile phone towers. The processor 102 may store information received through the input/output interface 106 in the data store 104 and may use the information in implementing the modules 112-116.

The I/O interface 106 may be a device interface to connect the computing device 100 to one or more I/O devices 120. The I/O devices 120 include, for example, a display, a keyboard, a mouse, and a pointing device, wherein the pointing device may include a touchpad or a touchscreen, among others. The I/O devices 120 may be built-in components of the computing device 100, or located externally to the computing device 100. The display includes a display screen of a smartphone, a computing tablet, a computer monitor, a television, or a projector, among others. In some examples, the display is associated with a touch screen to form a touch-sensitive display. The touch screen allows a user to interact with an object shown on the display by touching the display with a pointing device, a finger, or a combination of both.

The computing device 100 also includes, for example, a graphics processing unit (GPU) 122. As shown, the processor 102 is coupled through the bus 105 to the GPU 122. The GPU 122 performs any number of graphics operations within the computing device 100. For example, the GPU 122 renders or manipulate graphic images, graphic frames, videos, or the like, that may be displayed to a user of the computing device 100. The processor 102 is also linked through the bus 105 to a camera 124 to capture an image, where the captured image is stored to the data store 104. Although the camera 124 is shown as internal to the computing device 100, the camera 124 may also be externally connected to the computing device 100 through the I/O device 120 according to an example.

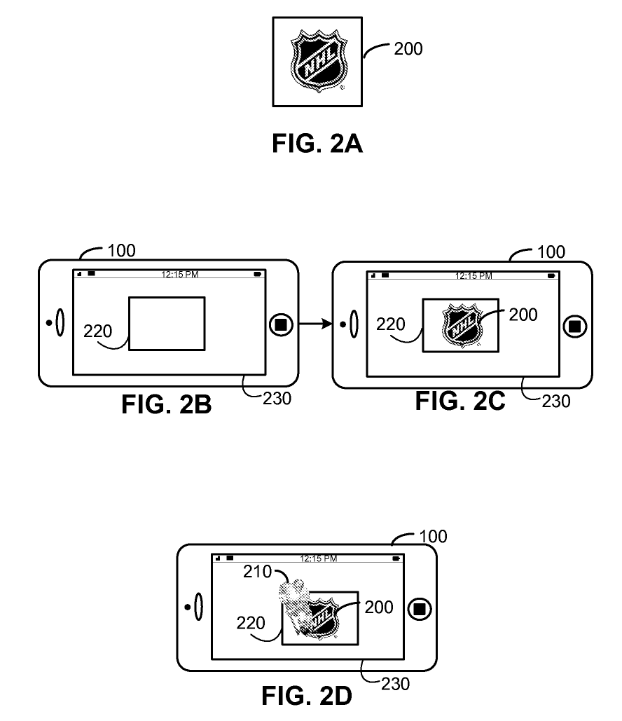

FIGS. 2A-2D are drawings of sequentially created frames that demonstrate a method to display an augmented reality experience without a physical trigger, according to an example of the present disclosure.

In FIG. 2A, a National Hockey League (NHL)® logo 200 is selected as a trigger image from among a plurality of trigger images. According to an example, a user interface may be displayed on the computing device 100, which includes a catalog of the plurality of trigger images. Each trigger image of the plurality of trigger images, for example, is associated with a unique augmented reality experience. The augmented reality experience includes at least one of an image, a video, a sound, a link to a web page, and a three-dimensional graphic or animation. In this example, the NHL® logo 200 is the trigger image, and the NHL® logo 200 is associated with the augmented reality experience of an image of a hockey player 210. As shown in FIG. 2A, the selection module, for instance, 112 receives a user selection of the NHL® logo 200 as the trigger image from the plurality of trigger images and imports the NHL® logo 200 and the image of a hockey player 210 from the local data store 104 or a remote database server.

After the trigger image is selected by the selection module 112, the user initiates a preview mode on the computing device 100, as shown in FIG. 2B. The preview mode, for instance, activates the camera 124 of the computing device 100. When the camera 124 is activated, the detection module 114 may display a message for a user to locate a planar surface 220 from the real-world environment using a viewfinder display 230 of the computing device 100. The planar surface 220 may serve as a boundary within which the trigger image may be overlaid on the viewfinder display 230. Once the detection module 114 detects that the user has successfully located a rectangular planar surface 220 to frame the NHL® logo 200 as shown in FIG. 2B, the detection module 114 may display a notification, such as an animation, message, or audible or tactile alert, to notify the user that a suitable planar surface 220 is identified.

In FIG. 2C, the overlay module 116, for example, superimposes the NHL® logo 200 on the camera feed of the suitable planar surface 220 on the viewfinder display 230 of the computing device 200. As shown in FIG. 2D, the overlay module 116, for example, superimposes an augmented reality experience on top of at least a portion of the superimposed NHL® logo 200. In this example, the augmented reality experience that is associated with the NHL® logo 200 is an image of a hockey player 210. Further, the image of the hockey player 210 may extend beyond the boundary of a captured view of the planar surface within the viewfinder display 230. Thus, in the preview mode, the augmented reality experience is activated for display on the computing device 100 without a physical trigger from a real-world environment. According to another example, the augmented reality experience that is associated with the NHL® logo 200 may be any digital media including at least one of an image, a video, a sound, a link to a web page, and a three-dimensional graphic or animation, that provides informational context about the trigger image of the NHL® logo 200.

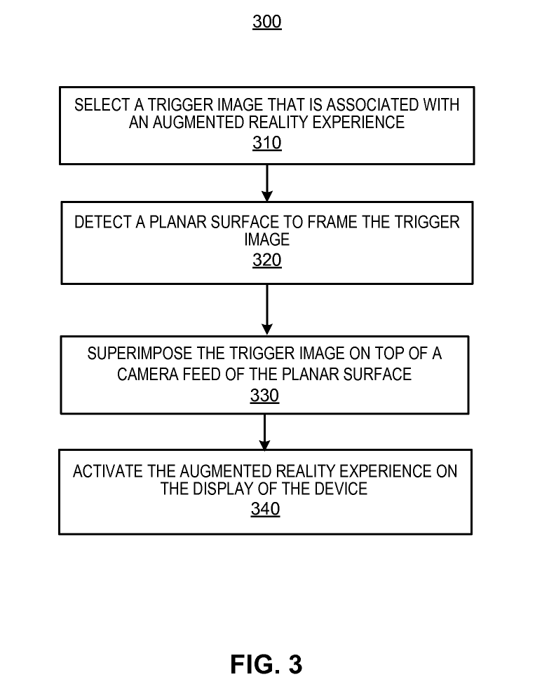

With reference to FIG. 3, there is shown a flow diagram of the method 300 to display an augmented reality experience without a physical trigger, according to an example of the present disclosure. The method 300 is implemented, for example, by the processor 102 of computing device 100 as depicted in FIG. 1.

In FIG. 3, the selection module 112 of the augmented reality platform 110 selects a trigger image for an augmented reality experience, as shown in block 310. According to an example, the trigger image is selected by a user from catalog of a plurality of trigger images that is displayed on a user interface on the display of the computing device 100. Each of the plurality of trigger images, for example, is associated with at least one unique augmented reality experience. The augmented reality experience for the trigger image may be any digital media that provides informational context about the real-world environment of the trigger image. For example, the digital media includes at least one of an image, a video, a sound, a link to a web page, and a three-dimensional graphic or animation.

In response to receiving a user selection of the trigger image from the plurality of trigger images, the selection module 112 imports the selected trigger image along with its associated augmented reality experience to the local data storage 104 of the computing device. According to an example, both the selected trigger image and its associated augmented reality experience are stored in a remote database server.

After the trigger image is selected by the selection module 112 in block 310, a user may initiate a preview mode on the computing device 100. The preview mode, for instance, activates the camera 124 of the computing device 100. Using the camera 124 of the computing device 100, the detection module 114 detects a planar surface from the real-world environment to frame the trigger image, as shown in block 320. Particularly, according to an example, the detection module 114 displays a message for a user to locate a suitable planar surface using the display of the camera 124 of the computing device 100.

A suitable planar surface, for instance, may be rectangular in shape to form a boundary or frame for the trigger image. That is, the rectangular planar surface determines the size of the trigger image and the placement of trigger image on the display of the computing device 100. The suitable planar surface allows the detection module 114, for instance, to detect an angle of the plane relative to the computing device 100. The detected angle of the plane provides spatial awareness to the overlay module 116 for superimposing a 3D model or graphic on top of the trigger image, as discussed in block 330 below.

Once the user has successfully located a rectangular planar surface to frame trigger image in the display of the computing device 100, the detection module 114 displays a notification, such as an animation, message, or audible or tactile alert, on the display of the computing device 100 to notify the user that a suitable planar surface is identified according to an example.

In block 330, the overlay module 116, for instance, superimposes the trigger image on top of the camera feed of the planar surface on the display of the computing device 200. Superimposing may include overlaying the trigger image on a captured view of the planar surface on the display of the device. For example, the trigger image is overlaid within the boundary of the captured view of the planar surface. Accordingly, the overlay module 116 may then superimpose the augmented reality experience on top at least a portion of the superimposed trigger image. For instance, unlike the superimposed trigger image, the augmented reality experience may extend beyond the boundary of a captured view of the planar surface within the viewfinder display 230.

As shown in block 340, the augmented reality experience is then activated on the display of the device without requiring a physical trigger from the real-world environment according to the disclosed examples. Activating the augmented reality experience may include generating a digital media overlay on top of the superimposed trigger image.

Thus, the method 300 shown in FIG. 3 provides the benefit and incentive of increased usability of an augmented reality platform by retaining users that do not have access to physical triggers. What has been described and illustrated herein are examples of the disclosure along with some variations. The terms, descriptions and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

What is claimed is:

1. A method to display an augmented reality experience without a physical trigger, comprising:
selecting, by a processor, a trigger image for an augmented reality experience;
detecting a planar surface in a real-world environment to frame the trigger image;
superimposing the trigger image on top of a camera feed of the planar surface; and
activating the augmented reality experience on a display, wherein the augmented reality experience includes the superimposed trigger image.

2. The method of claim 1, wherein the activating of the augmented reality experience includes superimposing the augmented reality experience on top of superimposed trigger image.

3. The method of claim 1, wherein the augmented reality experience includes at least one of an image, a video, a sound, a link to a web page, and a three- dimensional graphic or animation.

4. The method of claim 1, wherein the selecting of the trigger image includes:
displaying a user interface including a plurality of trigger images, wherein each trigger image of the plurality of trigger images is for an augmented reality experience; and
receiving a user selection of the trigger image from the plurality of trigger images.

5. The method of claim 1, wherein the detecting of the planar surface in a real- world environment includes:
displaying a message for a user to locate the planar surface using the camera of the device; and
displaying a notification responsive to the user locating the planar surface to frame the trigger image.

6. The method of claim 1, wherein the planar surface is a shape of a rectangle.

7. The method of claim 1, wherein the selecting of the trigger image includes importing the trigger image and the augmented reality experience from a remote database server.

8. An system to display an augmented reality experience without a physical trigger, comprising:
a processor;
a memory storing machine readable instructions that are to cause the processor to:
select a trigger image that is associated with an augmented reality experience;
identify a planar surface in a real-world environment as a boundary within a display for the trigger image;
overlay the trigger image within the boundary of a captured view of the planar surface, wherein the augmented reality experience is superimposed on top of at least a portion of the trigger image; and
initiate the augmented reality experience within the display.

9. The system of claim 8, wherein to select the trigger image, the machine readable instructions are to cause the processor to:
display a user interface including a plurality of trigger images, wherein each trigger image of the plurality of trigger images is associated with a unique augmented reality experience; and
receive a user selection of the trigger image from the plurality of trigger images.

10. The system of claim 8, wherein to detect the planar surface in the real-world environment, the machine readable instructions are to cause the processor to:
display a message for a user to locate the planar surface using the camera of the device; and
display a notification responsive to the user locating the planar surface.

11. The system of claim 8, wherein to select the trigger image, the machine readable instructions are to cause the processor to import the trigger image and the augmented reality experience from a remote database server.

12. The system of claim 8, wherein to activate the augmented reality experience, the machine readable instructions are to cause the processor superimpose the augmented reality experience including at least one of an image, a video, a sound, a link to a web page, and a three-dimensional graphic or animation.

13. A non-transitory computer readable medium to display an augmented reality experience without a physical trigger, including machine readable instructions executable by a processor to:
receive a selection of a trigger image for an augmented reality experience from a plurality of stored trigger images;
detect a planar surface in a real-world environment to frame the trigger image;
activate a preview mode displaying a captured view of the planar surface on a display device;
superimpose the trigger image on the captured view of the planar surface; and
activate the augmented reality experience mode on the display device, wherein the augmented reality experience mode displays the augmented reality experience on the superimposed trigger image.

14. The non-transitory computer readable medium of claim 13, wherein to detect the planar surface, the machine readable instructions are executable by a processor to:
display a message for a user to locate the planar surface using a camera of the display device; and
display a notification responsive to the user successfully locating the planar surface.

15. The non-transitory computer readable medium of claim 13, wherein to activate the augmented reality experience, the machine readable instructions are executable by a processor to superimpose the augmented reality experience including at least one of an image, a video, a sound, a link to a web page, and a three-dimensional graphic or animation onto the trigger image.
